(19) United States
(12) Patent Application Publication
(10) Pub. No.: US 2024/0025765 A1
(43) Pub. Date: Jan. 25, 2024

(54) FILTERED DIVERTER VALVE SYSTEM

(71) Applicant: Speakman Company, Glen Mills, PA (US)

(72) Inventors: Victor Michael CAROSI, Philadelphia, PA (US); Jeffrey Brian Harwanko, Wilmington, DE (US)

(73) Assignee: Speakman Company, Glen Mills, PA (US)

(21) Appl. No.: 18/224,219

(22) Filed: Jul. 20, 2023

Related U.S. Application Data
(60) Provisional application No. 63/391,268, filed on Jul. 21, 2022.

(51) Int. Cl. C02F 1/00; E03C 1/04; F16K 11/085

(52) U.S. Cl. CPC C02F 1/003; E03C 1/0408; F16K 11/0853; C02F 2307/06

(57) ABSTRACT

Filtered diverter valve systems are disclosed that provide filtered water to a diverter valve for diverting filtered water to one or more plumbing fixtures. In particular, the filtered diverter valve systems will include a lower valve body housing, a valve cap, a diverter valve system, and a filtration member. In operation, water flows through the filtration member prior to entering the diverter valve system. As such, filtered water can be diverted to one or more plumbing fixtures, such as a showerhead or hand shower. Methods of using a filtered valve systems are also disclosed.

### CROSS-REFERENCE TO RELATED APPLICATIONS

This claims the benefit of the filing date of U.S. Provisional Application No. 63/391,268, filed Jul. 21, 2022, the entire content of which is incorporated by reference herein.

### FIELD OF THE INVENTION

The present invention generally relates to diverter valve systems for directing the flow of water from one path to another. Specifically, the invention relates to a diverter valve system that can be attached to a shower arm and/or other external water flow pipe/hose and includes a filter component such that filtered water can be directed from one flow path to another, for example, from a showerhead to a hand shower and vice versa.

### BACKGROUND OF THE INVENTION

Diverter valves are used in many applications to direct the flow of water from one flow path to another. Common applications include, for example, bathing installations, whirlpool paths, spas, kitchen sink installations, and the like. Bathing installations may include diverter valves that direct the flow of water under pressure from one outlet, such as the tub faucet, to another outlet, such as the showerhead, hand shower, or body spray.

However, diverter valves and plumbing fixtures, such as showerheads, hand showers, and lavatory and kitchen faucets in general, are susceptible to problems resulting from contaminants, dirt particles, mineral deposits, and other foreign material in the water that can build up in the valve components or at the water outlets of the plumbing fixtures thereby preventing proper operation. For instance, dirt or mineral deposit buildup in the showerhead spray outlets can create uneven water coverage or errant streams of water that reduce the effectiveness of the shower while potentially creating slippery surfaces outside the shower stall or area. These issues often require cleaning and/or replacement of the plumbing/valve components. Further, harmful contaminants, such as free chorine, may damage hair, cause odor, and otherwise negatively impact the bathing experience.

Existing filter systems incorporate replaceable filter components or filtration media cartridges into, for example, showerheads to alleviate particle and mineral buildup in the shower spray outlets. However not all showerheads can be retrofitted for or are compatible with all types of filtration cartridges available in the art. Other filtration systems are external to the showerhead and connect to the showerhead and the shower arm, which allow for ease of compatibility to the majority of existing showerheads. However, both examples can only protect one of the water outlets at a time while leaving other outlets susceptible to foreign particle and mineral buildup. Moreover, the need to incorporate a filtration element into each water outlet (e.g., hand shower, tub faucet, and the like) lead to increased costs and time spent with replacements and installation while reducing the external space in the existing shower system.

Therefore, there exists a need in the art for better filtration and diverter valve systems that can be used externally to the inner plumbing works and that reduces or eliminates contaminants and odors, dirt, and/or mineral deposits from multiple water outlets while being easily accessible.

### SUMMARY OF THE INVENTION

Described herein are filtered diverter valve systems that are intended to overcome the shortcomings of known systems, have disposable filtration components that are easily accessible and replaceable, are designed to minimize any increase in steppage, and which can be modified to fit any bathing or kitchen installation to produce a diverter valve system capable of delivering filtered water to multiple water outlets. The novel and innovative designs of the filtered diverter valve system disclosed and described herein combine the filtration member with the diverter valve such that the water is filtered prior to being diverted to one or more water outlets. Moreover, the filtered diverter valve system design enables connection to plumbing fixtures that are external to walls, floors, etc. so that the user can easily attach the system to any combination of bathing or kitchen fixtures and easily access and replace the filtration member or filter medium from time to time. Moreover, in some embodiment, the inlets and outlets are angled to mimic typical bathroom shower stall arrangements in order to minimize any increase in steppage that could negatively impact the showering experience. As such, the filtered diverter valve systems disclosed herein protect the diverter valve itself as well as multiple water outlets, e.g., showerheads, hand showers, body sprayers, kitchen and tub faucets, and the like, from contaminants (e.g., chlorine), dirt and other particles, and the buildup of mineral deposits (e.g., scaling) without requiring multiple filtration systems or extensive retrofitting of existing plumbing fixtures and while minimizing the external space taken up by the system. The design and arrangement of the filtered diverter system disclosed herein enables the end-user to easily replace the filtration member to improve the cleaning and bathing experience.

The filtered diverter valve system disclosed herein will have a valve body that includes a housing, a water supply inlet, one or more water outlets, a diverter valve system, and a filtration member. In preferred embodiments, the valve body comprises an upper portion and a lower portion that can be separated by the end-user to easily access and replace the disposable filtration member within. In such embodiments, the lower valve body housing of the filtered diverter valve system will include two or more water outlets. The water supply inlets and water outlets may comprise pipes or tubes, the ends of which preferably include an attachment component, such as, but not limited to, threaded pipe fittings, pipe slip couplings, swivel nuts, and the like, configured to enable attachment of the valve body to the existing plumbing fittings. In a preferred embodiment, the lower valve body housing is attached to a valve cap, and the diverter valve system and filtration member and are disposed within the lower valve body housing and valve cap, respectively, and in fluid communication with the water supply inlet and the water outlets. As water under pressure flows into the water supply inlet, the water flows into the filtration member and contacts the filter medium, which removes contaminants and dirt and mineral particles from the water. The diverter valve system then receives the filtered water from the filtration member to divert that filtered water to the one or more water outlets and then, ultimately to the plumbing fittings, such as, but not limited to, a showerhead and hand shower.

One aspect of the invention features a filtered diverter valve system comprising that includes a lower valve body and a valve cap. The lower valve body includes a lower chamber, a water supply inlet for connecting the filtered diverter valve system to a supply of water, a first water outlet, and a second water outlet. The first water outlet is configured for connecting to a first plumbing fixture, whereas the second water outlet is configured for connecting to a second plumbing fixture. The lower chamber includes a bottom portion and a top partition, the latter having a flowpath for receiving the flow of water. The valve cap has an upper chamber for receiving a disposable filtration member and also has a valve cap flowpath that is in fluid communication with the water supply inlet and configured to receive flow of water. The valve cap flowpath includes an opening in fluid communication with the disposable filtration member when the disposable filtration member is disposed within the upper chamber. Within the lower chamber of the lower valve body is a diverter valve member that includes (i) a diverter inlet in fluid communication with the diverter valve flowpath, (ii) at least one diverter outlet for fluid communication with the first water outlet, the second water outlet, or both the first water outlet and the second water outlet, and (iii) a diverter actuator movable between a first position and a second position. The diverter inlet and diverter valve flowpath are in fluid communication with the disposable filtration member when the disposable filtration member is disposed within the upper chamber. The filtered diverter valve system also has a control device for moving the diverter actuator between the first position and the second position, which diverts water to the first water outlet when the diverter actuator is in the first position and diverts water to the second water outlet with the diverter actuator is in the second position.

In some embodiments, the diverter actuator is moveable to a third position to divert water to both the first water outlet and the second water outlet. In other embodiments, the diverter valve member has a first diverter outlet in fluid communication with the first water outlet and a second diverter outlet in fluid communication with the second water outlet. In such embodiments, the movement of the diverter actuator between the first position and the second position enables flow of water to the first water outlet and the second water outlet, respectively.

In another embodiments, the filtered diverter valve system includes a filtration member disposed within the upper chamber of the valve cap. The filtration member may include a filter medium, such as, but not limited to polyphosphate, mesh, ceramic, activated carbon, catalytic carbon, silver carbon, kinetic degradation fluxion, a reverse osmosis membrane, activated aluminum, manganese dioxide, or any combination thereof. In other embodiments, the water supply inlet extends upward from the lower valve body at an angle of about 0 degrees to about degrees in relation to the horizontal axis of the lower valve body. In yet other embodiments, the first water outlet is on a side of the lower valve body opposite the water supply inlet and extends downward from the lower valve body at an angle of about 0 degrees to about 60 degrees in relation to the horizontal axis of the lower valve body. In still other embodiments, the water supply inlet extends upward from the lower valve body at an angle of about 35 degrees to about degrees and the first water supply outlet extends downward from the lower valve body at an angle of about 35 degrees to about 55 degrees.

In another embodiment, the second water outlet extends downward from the bottom of the lower valve body. In some aspects of the device, the lower valve body comprises a housing made from plastic, and the valve cap is made from plastic. Moreover, the diverter valve member further may include a housing in which is disposed the diverter actuator. Additionally, the diverter actuator may be a diverter actuator stem configured for rotation within a cylindrical body.

In yet other embodiments, wherein the valve cap includes a waterway adapter having a tube that is concentrically received within a counterpart inlet tube within the housing of the diverter valve member. As such, the tube of the waterway adapter and tube of the housing of the diverter valve member are configured to flow water from the water supply inlet to the valve cap flowpath. In some aspects, the filtration member has an interior enclosed by cylindrical side walls, a top, and a bottom, wherein the top has a top opening in fluid communication with the valve cap flowpath, wherein the bottom has a bottom opening in fluid communication with the diverter valve flowpath, and wherein the filter medium is disposed within the interior and configured for filtering water flowing through the filtration member. In other aspects, the top opening of the filtration member and the bottom opening of the filtration member are covered with a wire mesh.

In some embodiments of the filtered diverter valve system, the cylindrical side walls of the filtration member taper towards the top. In other embodiments, the first plumbing fixture is a showerhead, and wherein the second plumbing fixture is a hand shower. In yet other embodiments, the lower valve body comprises a holder for holding the hand shower and/or the control device is a knob that is operated manually to move the diverter actuator between the first position, the second position, and the third position.

Another aspect of the invention features a filtered diverter valve system that includes a lower valve body with a diverter valve housing that includes a diverter valve flowpath, a water supply inlet for connecting the filtered diverter valve system to a supply of water, a first water outlet, and a second water outlet, wherein the first water outlet is configured for connecting to a first plumbing fixture and the second water outlet is configured for connecting to a second plumbing fixture. The filtered diverter valve system of this aspect will also include a valve cap with an upper chamber for receiving a disposable filtration member, wherein the valve cap further comprises a valve cap flowpath in fluid communication with the water supply inlet and configured to receive flow of water, wherein the valve cap flowpath comprises an opening in fluid communication with the disposable filtration member when the disposable filtration member is disposed within the upper chamber. Moreover, there is a diverter valve member disposed within the diverter valve housing, wherein the diverter valve member includes a diverter inlet in fluid communication with the diverter valve flowpath, a first diverter outlet in fluid communication with the first water outlet, a second diverter outlet in fluid communication with the second water outlet, and a diverter actuator movable between a first position and a second position. As such, the diverter inlet and diverter valve flowpath are in fluid communication with the disposable filtration member when the disposable filtration member is disposed within the upper chamber. Further, the filtered diverter valve system includes a control device for moving the diverter actuator between the first position and the second position, wherein water is diverted to the first water outlet when the diverter actuator is in the first position, and wherein water is diverted to the second water outlet with the diverter actuator is in the second position.

In another embodiment, the diverter actuator is moveable to a third position, and wherein water is diverted to both the first water outlet and the second water outlet with the diverter actuator is in the third position. In operation, the filtered diverter valve system will preferably have a filtration member disposed within the upper chamber of the valve cap, wherein the filtration member comprises a filter medium selected from the group consisting of polyphosphate, mesh, ceramic, activated carbon, catalytic carbon, silver carbon, kinetic degradation fluxion, a reverse osmosis membrane, activated aluminum, manganese dioxide, and any combination thereof. In some embodiments, the diverter actuator is a diverter actuator stem configured for rotation within a cylindrical body.

In an embodiment, the valve cap comprises a waterway adapter having a tube that is concentrically received within a counterpart inlet tube within the diverter valve housing, and wherein the tube of the waterway adapter and tube of the diverter valve housing are configured to flow water from the water supply inlet to the valve cap flowpath. In a preferred embodiment, the first plumbing fixture is a showerhead, and wherein the second plumbing fixture is a hand shower.

Yet another aspect of the invention features a filtered diverter valve system that includes a valve cap, a lower valve body, and a diverter valve member. The lower valve body has a lower chamber configured for receiving a disposable filtration member, a water supply inlet for connecting the filtered diverter valve system to a supply of water, a first water outlet, and a water valve outlet. The first water outlet is configured for connecting to a first plumbing fixture while the second water outlet is configured for connecting to a second plumbing fixture. In addition, the lower chamber includes a first flowpath in fluid communication with the water supply inlet and the disposable filtration member when the disposable filtration member is disposed within the lower chamber. The diverter valve member is disposed within the lower chamber of the lower valve body and has (i) a diverter inlet in fluid communication with the disposable filtration member when the disposable filtration member is disposed within the lower chamber, (ii) at least one diverter outlet for fluid communication with the first water outlet, the second water outlet, or both the first water outlet and the second water outlet, and (iii) a diverter actuator movable between a first position and a second position. The filtered diverter valve system also includes a control device for moving the diverter actuator between the first position and the second position. In this manner, water is diverted to the first water outlet when the diverter actuator is in the first position and diverted to the second water outlet with the diverter actuator is in the second position. In particular embodiments, the diverter actuator is further moveable to a third position to divert water to both the first water outlet and the second water outlet.

In an embodiment, the diverter valve member has a first diverter outlet in fluid communication with the first water outlet and a second diverter outlet in fluid communication with the second water outlet, and wherein the movement of the diverter actuator between the first position and the second position enables flow of water to the first water outlet and the second water outlet, respectively. In yet another embodiment, the filtered diverter valve system includes a filtration member disposed within lower chamber, which typically includes a filter medium, such as, but not limited to polyphosphate, mesh, ceramic, activated carbon, catalytic carbon, silver carbon, kinetic degradation fluxion, a reverse osmosis membrane, activated aluminum, manganese dioxide, or any combination thereof. In some embodiments, the diverter valve member has a housing in which is disposed the diverter actuator, and the diverter actuator is a diverter actuator stem configured for rotation within a cylindrical body. In particular embodiments, the first plumbing fixture is a showerhead, and the second plumbing fixture is a hand shower.

Other features and advantages of the invention will be apparent by reference to the drawings, detailed description, and examples that follow.

### BRIEF DESCRIPTION OF THE DRAWINGS

FIG. 1 is an embodiment of a shower system that includes a filtered diverter valve system attached to a showerhead and hand shower.

FIG. 2 is a perspective view of an embodiment of the filtered diverter valve system. The second water outlet is not visible in this view.

FIG. 3 is a front view of an embodiment of the filtered diverter valve system.

FIG. 4 is a side view of an embodiment of the filtered diverter valve system.

FIG. 5 is an exploded view of an embodiment of the filtered diverter valve system.

FIG. 6A is a front perspective view of an exemplary filtration member

FIG. 6B is a photograph of a view of an exemplary filtration member.

FIG. 6C is a photograph of a perspective view of an exemplary filtration member showing the bottom surface of the filtration member.

FIG. 6D is an embodiment of a diverter system housing.

FIG. 6E is an embodiment of a diverter actuator stem.

FIG. 6F is an embodiment of a diverter actuator body.

FIG. 7A is a side cross-sectional view of an embodiment of the filtered diverter valve system. The arrows within the flowpaths indicate the direction of the water flow.

FIG. 7B is a front cross-sectional view of an embodiment of the filtered diverter valve system.

### DETAILED DESCRIPTION OF THE INVENTION

The filtered diverter valve systems described herein have a novel and innovative design that includes a valve body comprised of an upper portion and lower portion, sometimes referred to herein as the lower valve body and valve cap, respectively. The lower valve body will comprise a lower valve body housing, and also includes a water supply inlet and one or more water outlets. In preferred embodiments, the lower valve body of the filtered diverter valve system includes two or more water outlets, with each water outlet extending externally to the lower valve body housing and is connectable to a different plumbing fixture (e.g., showerhead and hand shower).

Within the upper valve portion or valve cap of preferred embodiments is an upper chamber for insertion of a disposable filtration member that includes suitable filter medium or media. The valve cap will include a water flowpath that generally flows up from the water supply inlet of the lower valve body and across the top of the valve cap in order to deliver water into the top of the filtration member. In other embodiments, the disposable filtration member is positioned in the lower chamber where water flows in from the water supply inlet. The flow of water from the water supply inlet to the filtration member is sometimes referred to herein as the “valve cap flowpath”.

Within the lower valve body is a diverter valve system. While the diverter valve system can be adapted to include any art-standard diverter valve, in a particular embodiment, the diverter valve system includes a diverter actuator stem that rotates with a cylindrical diverter actuator body. In this embodiment, the diverter actuator body has an inlet forming a flowpath for water as is typical of these types of diverter valves available in the art. When the disposable filtration member is within the upper chamber of the valve cap (or within the lower chamber of the lower valve body in some embodiments), the diverter valve system flowpath is in fluid communication with the valve cap flowpath and configured to divert the flow of water under pressure from the filtration member through the water outlet(s) and to one or more plumbing fixtures. As one having ordinary skill in the art will readily appreciate, water flows into the diverter valve system inlet, over the diverter actuator stem, and through the diverter actuator body outlet(s) to one or both of the water outlets depending on the positioning of the diverter actuator stem. In some embodiments, the filtration member is also within the lower chamber and positioned adjacent to the diverter valve system. For any of the above-described locations of the filtration member, the water flows from the water supply inlet and into the filtration member prior to entering the diverter valve system. The flow of water from the filtration member, through the diverter valve system, and to the water outlet(s) is sometimes referred to herein as the “diverter valve flowpath”.

In general, the filtration member is positioned between the valve cap flowpath and the diverter valve flowpath so that it can filter water as it flows from the water supply inlet to the diverter valve system. The user can switch the position of the valve actuator stem to divert the flow of filtered water to either the first water outlet or the second water outlet or both outlets simultaneously using a manual (or electronic) control device on the outside surface of the lower valve body housing. In this design, since the water flows through the filter medium of the filtration member before it enters the diverter valve system, only filtered water is diverted to the plumbing fixtures thus removing/reducing contaminants from the water and/or preventing the buildup of dirt and minerals at the outlets of these fixtures.

In one embodiment, the lower chamber of the lower valve body and the upper chamber of the valve cap will be physically separated by a partition that may be integral or machined into the valve body. Alternatively, the partition can be part of a separate component that is assembled into the lower chamber and can provide the top of the lower chamber. For instance, in a particular embodiment, the diverter valve system is disposed within a diverter valve system housing, and the top of the diverter valve system housing forms the partition. The partition or top of the diverter valve system housing will have a bore or hole for flowing water from the filtration member into the diverter valve system flowpath.

When the filtration member is inserted into the valve cap, and the valve cap is affixed to the lower valve body, the filtration member is disposed on the top surface of the partition or diverter valve system housing with the interior portion containing the filter medium in fluid communication with both the valve cap flowpath and the diverter valve system flowpath. As water under pressure enters the lower valve body through the water supply inlet, the water flows through a pipe, tube, gap, or bridge (i.e., a flowpath) through the valve cap flowpath and into the top of the filtration member. The top of the filtration member will contain an opening or filtration inlet that, optionally, is covered by a wire mesh to prevent the filter medium from being washed away and to remove larger particles. As the water passes through the filtration member, it contacts the filter medium (or media) within, which removes contaminants, dirt particles, and mineral deposits depending on the particular medium selected. The filtered water then passes out of an opening or openings in the bottom of the filtration member and into the diverter valve system flowpath. In particular embodiments, the opening(s) in the bottom of the filtration member is also covered with a wire mesh to prevent the filter medium from being washed away.

For instance, in one non-limiting embodiment, the filtered diverter valve system is connected to a supply of water under pressure, a showerhead, and a hand shower. The diverter valve system can then be operated to divert the filtered water to the showerhead or the hand shower (or both) depending on the position of the diverter actuator stem in relation to the diverter actuator body outlets. If the filter medium of the filtration member becomes clogged or its useful life expires, the user can easily separate the valve cap (e.g., unthread or uncouple) from the lower valve body and replace the filtration member with a new one. The various components will now be described in further detail below.

Unless defined otherwise, all technical and scientific terms used herein have the same meaning as those commonly understood by one of ordinary skill in the art to which this invention belongs. Standard techniques are used unless otherwise specified. Although methods and materials similar or equivalent to those described herein can be used in the practice or testing of the present disclosure, suitable methods and materials are described below. The materials, methods and examples are illustrative only, and are not intended to be limiting. All publications, patents and other documents mentioned herein are incorporated by reference in their entirety.

Ranges, if used, are used as shorthand to avoid having to list and describe each and every value within the range. Any value within the range can be selected, where appropriate, as the upper value, lower value, or the terminus of the range.

As used herein, the singular forms “a,” “an,” and “the” include the plural referents unless the context clearly indicates otherwise. Likewise, the terms “include”, “including”, and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The term “about” refers to the variation in the numerical value of a measurement, e.g., diameter, weight, length, volume, angle degrees, etc., due to typical error rates of the device used to obtain that measure. In one embodiment, the term “about” means within 5% of the reported numerical value, preferably, the term “about” means within 3% of the reported numerical value.

The term “comprising” is intended to include embodiments encompassed by the terms “consisting essentially of” and “consisting of” Similarly, the term “consisting essentially of” is intended to include embodiments encompassed by the term “consisting of.”

The term “substantially” as used herein to refer to lateral, horizontal, vertical, or perpendicular means within 5 degrees of lateral, horizontal, vertical, or perpendicular orientation; preferably, within 3 degrees of the lateral, horizontal, vertical, or perpendicular orientation.

The filtered diverter valve system of this disclosure will be connectable to external plumbing fixtures, such as, but not limited to, a showerhead, a shower arm, hand shower, sink faucet, body sprayer and the like. Each of the water supply inlet and water outlets of the valve body will include an attachment component typically found in the art, such as pipe threads, pipe slip couplings, swivel nuts, and the like. This enables the end-user to attach the filtered diverter valve system to any bathing or kitchen fixture without the need to retrofit particular plumbing fixture components. For instance, the user can unthread or uncouple the showerhead from the shower arm and then thread or couple the shower arm to the water supply inlet of the lower valve body housing and the showerhead to one of the water outlets of the lower valve body housing. If the lower valve body housing includes a second water outlet, it can be threaded or coupled, e.g., to a hose for a hand shower. Since the filtration member is disposed within the valve cap (or, in some embodiments, the lower valve body) upstream of and in fluid communication with the diverter valve system, a single filtration component is configured to supply filtered water to the diverter valve system and, ultimately, to either water outlet. Moreover, since the filtered diverter valve system is connected to plumbing fixtures that are external to the bathroom walls, floors, or ceilings, the end-user can easily replace the filter media without having to remove drywall, crack plaster, break cement, and the like.

As noted above, the diverter valve system includes a lower valve body having a lower chamber and an upper portion or valve cap within which is the upper chamber. In general, the interior components of the lower valve body (e.g., the diverter valve member) are protected by the lower valve body housing. The lower valve body housing can be made from any suitable material, such as, but not limited to rigid plastics (e.g., polyvinyl chloride (PVC)), acrylonitrile butadiene styrene (ABS) plastic), stainless steel, brass, and any combination thereof. In particular embodiments, the lower valve body housing is made from ABS plastic and coated or plated with, for example, chrome plating, brush nickel, matte black, and the like. Likewise, the valve cap can be made of the same material as the lower valve housing or of a different material, such as, but not limited to, rigid plastics (e.g., polyvinyl chloride (PVC)), acrylonitrile butadiene styrene (ABS) plastic), stainless steel, brass, and any combination thereof. In particular embodiments, the valve cap is made from ABS plastic and coated or plated with, for example, chrome plating, brush nickel, matte black, and the like. The valve cap is attached or affixed to the lower valve body housing by threading, friction fit, or other suitable attachment means. In the embodiments, as shown in the drawings, a locking ring holds the valve cap and lower body housing together and can easily be unlocked by the end-user.

When assembled, the lower valve body housing and valve cap may have a height (not including the water supply inlets or water outlets) of about 2 inches to about 6 inches. If the filtration member is disposed next to the diverter valve system in the lower valve body, the height of the device can be towards the lower end of this range. In preferred embodiments, the filtered diverter valve system will generally be cylindrical having a diameter of between about 2 inches and about 6 inches depending on the size of the filtration member used and where it is positioned within the device. Thus, the filtered diverter valve system will not significantly reduce the amount of space available in the shower/washing area.

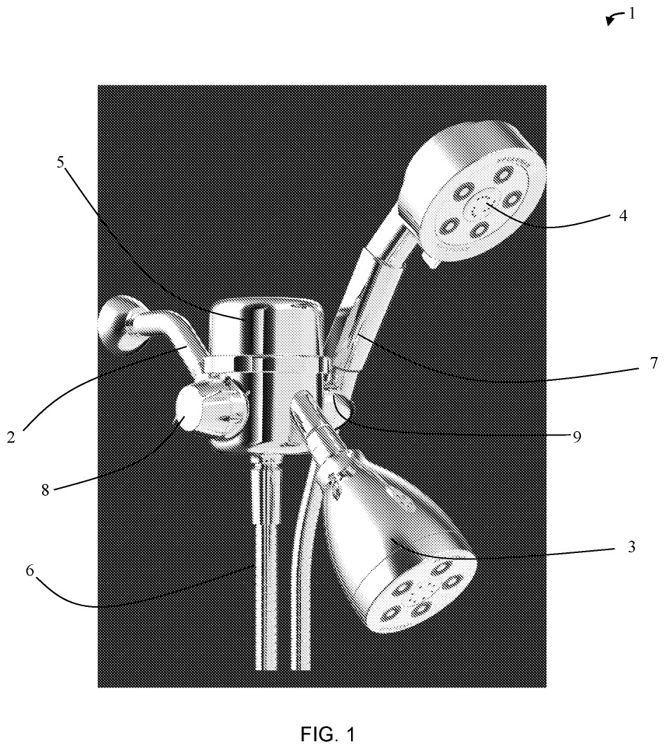

In one embodiment, the filtered diverter valve system is used in a bathing fixture having a showerhead fixture component and a hand shower fixture component. Since the filtered diverter valve system is connected to both the shower arm and the showerhead fixture, it may be desirable to include angles or bends in the water supply inlet and showerhead valve outlet to maintain an orientation of the showerhead typical for most shower fixture arrangements and to minimize the impact on horizontal steppage that may negatively impact the end-user shower experience. As such, the water supply inlet may extend laterally from the bottom half of the lower valve body housing, but angled upwards at an angle of about 0 degrees to about 60 degrees, e.g., 0 degrees, 5 degrees, 10 degrees, 15 degrees, 20 degrees, 25 degrees, 30 degrees, 35 degrees, 40 degrees, 45 degrees, 50 degrees, 55 degrees, or 60 degrees, as measured from the horizontal axis of the lower valve body. In a particular embodiment, the water supply inlet is angled upwards at an angle from about 35 degrees to about 55 degrees as measured from the horizontal axis. For instance, in the embodiments depicted in FIGS. 1-4, the water supply inlet is angled upwards at about 45 degrees. Likewise, one of the water outlets may extend laterally from the lower valve body housing on the opposite side from the water supply inlet and angled downwards at an angle of about 0 degrees to about 60 degrees, e.g., 0 degrees, 5 degrees, 10 degrees, 15 degrees, 20 degrees, 25 degrees, 30 degrees, 35 degrees, 40 degrees, 45 degrees, 50 degrees, 55 degrees, or 60 degrees, as measured from the horizontal axis of the lower valve body. In a particular embodiment, the water outlet is angled downwards at an angle from about 35 degrees to about 55 degrees. For instance, in the embodiments depicted in FIGS. 1-4, the first water outlet is angled downwards at about 45 degrees. In such embodiments, the second water outlet (e.g., for the hand shower) may extend downward from the base of the lower valve housing.

The upper chamber and lower chamber may be separated by a partition having a hole or bore such that water can pass from one chamber to the other chamber (preferably, from the upper chamber to the lower chamber). When the filtration member is disposed within the filtered diverter valve system, water passes from the water supply inlet and valve cap flowpath of the upper chamber to the diverter valve flowpath of the lower chamber. As noted above, a diverter valve system housing may be disposed within the lower chamber to provide the partition between the upper and lower chambers and to house the diverter valve components (e.g., a diverter actuator stem and cylindrical diverter actuator body). The water supply inlet and valve water may be separate pipes or tubes or machined into the lower valve body housing as is typical in the art for such components.

The filtration member suitable for use herein may be a cartridge-type component that houses filter medium within its interior and includes an inlet portion and an outlet portion to allow water to flow through the interior and contact the filter medium. For instance, the filtration member may be a plastic container filled with a suitable filter medium. The inlet and outlet of the filtration member may include holes or bores for allowing the flowthrough of water. To prevent the filter medium from being washed away or forced out of the filtration member by the flow of water under pressure, a wire mesh or other type of screen can be used to cover the top and/or bottom inlets of the filtration member. Further, the wire mesh reduces or prevents larger particles or contaminants from entering or clogging the filtration member. The particular filter medium selected for use will depend on what types of contaminants or other foreign material the end-user desires to remove from the water flow.

Many different types of filter media may be used in the present invention, depending on the desires of the end-user. For instance, the filter medium may be a mechanical filter medium that physically removes sediment, dirt, or other particles in the water using a barrier. These types of filters can be made from any suitable material, such as, but not limited to basic mesh, ceramic, and the like and fabricated with a rating ranging from 0.3 microns to 100 microns or more, e.g., 0.3 microns, 0.5 microns, 1 micron, 2 microns, 3 microns, 4 microns, 5 microns, 10 microns, 20 microns, 30 microns, 40 microns, 50 microns, 60 microns, 70 microns, 80 microns, 90 microns, 100 microns, or more. Other filter media may include an absorption filter medium, such as activated carbon or catalytic carbon, which are made from wood, coal, coconut shells and the like. Activated carbon or catalytic carbon can bind to and remove organic contaminants, such as chlorinated byproducts, lead, copper, some pesticides, and even some odors. Suitable filter media may include sequestration type filter media, such as polyphosphate used to reduce scaling caused by calcium and/or magnesium mineral deposits. Further, ion exchange or reverse osmosis filter media may also be used in the filtration member. Ion exchange filter media may include activated aluminum that can also remove calcium and magnesium. Activated aluminum can also remove fluoride and arsenic. Manganese dioxide can remove iron, manganese, and hydrogen sulfide from water. Kinetic Degradation Fluxion (KDF) filter media are primarily comprised of copper and zinc particles and can reduce the levels of water-soluble heavy metals, such as chlorine, iron, and hydrogen sulfide, and can also reduce some bacteria and algae from the flow of water. Exemplary KDF media include KDF-55, which reduces/removes chlorine, odor, heavy metal and bacteria, and KDF-85, which reduces/removes iron and hydrogen sulfide. In other embodiments, a combination of these types of filter media can be used (mixed media). Therefore, in some embodiments, the filter media or medium comprises polyphosphate, mesh, ceramic, activated carbon, catalytic carbon, silver carbon, kinetic degradation fluxion, a reverse osmosis membrane, activated aluminum, manganese dioxide, or any combination thereof.

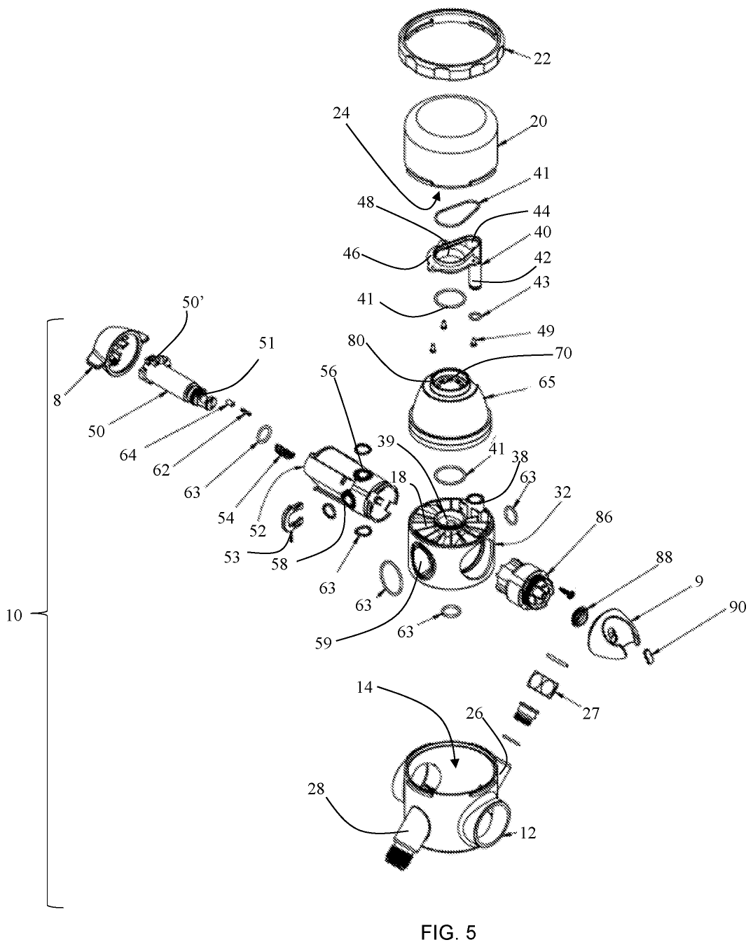

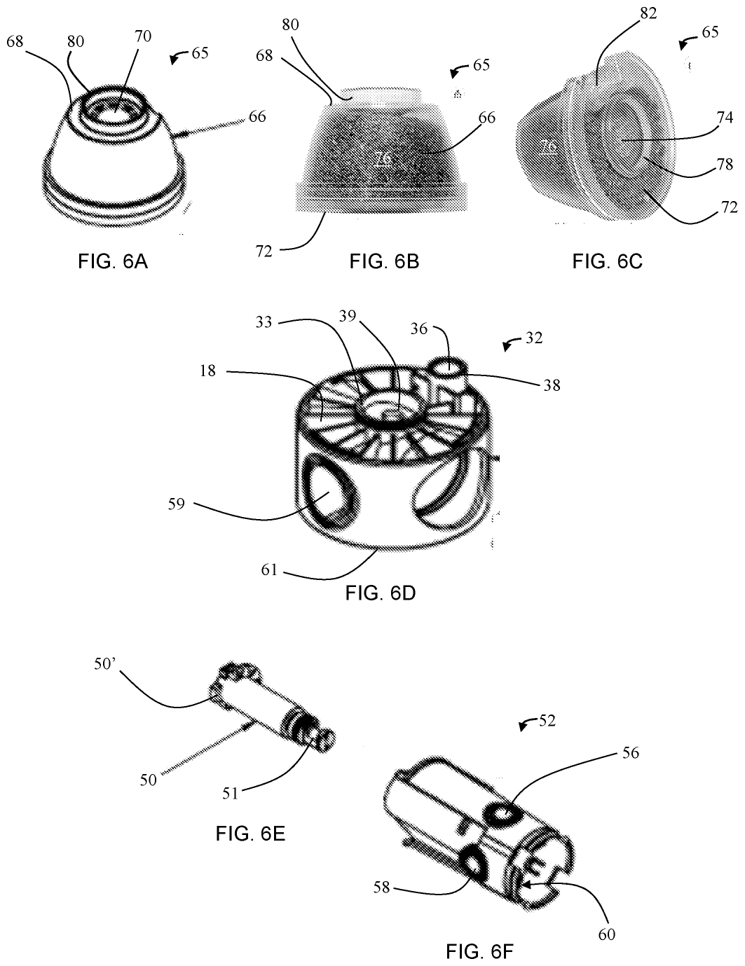

In a particular embodiment, such as the embodiment depicted in FIGS. 5 and 6A-6C, the filtration member is a plastic cartridge or container filled with one or more filter media and having an inlet at the top and an outlet at the bottom. The filtration member will preferably be disposable after, e.g., 3-6 months of use. The filtration member generally sits on the top of the lower chamber partition or diverter valve system housing such that the outlet of the filtration member is in fluid communication with the bore of the partition and the diverter valve system flowpath. The top of the filtration member will be in communication with valve cap flowpath when the filtration member is inserted into the valve cap or when the filtration member is disposed onto the diverter valve system housing and the valve cap affixed to the lower valve body housing. The valve cap may also include a partition that separates the water supply inlet flow from the upper chamber that houses the filtration member. In one particular embodiment, the valve cap includes a waterway adapter for flowing water from the water supply inlet though the upper chamber of the valve cap. Further, the filtration member may include a notch along the length of its sidewall to mate with the partition to hold the filtration member in place or provide a space for the waterway adapter.

The diverter valve system is disposed within the lower chamber and in fluid communication with the water supply inlet (when fully assembled with a filtration member) and the water outlet(s). When the filtration member is in place, the water flows from the water supply inlet, through the valve cap flowpath, down through the filtration member, and into the diverter valve system via the bore of the partition or diverter valve system housing. In one particular embodiment, the diverter valve system will include a diverter actuator stem that rotates within a cylindrical diverter actuator body in response to operation of a control device, such as a knob, on the outer surface of the lower valve body housing (e.g., a swivel nut/flow controller). The cylindrical diverter actuator body will have an inlet in fluid communication with the valve cap flowpath and two or more outlets in communication with the water outlets. These inlet and outlets can be referred to herein as the diverter actuator body inlet and diverter actuator body outlets. As the diverter actuator stem rotates between a first position and a second position, the filtered water is diverted to flow through the first diverter actuator valve body outlet or the second diverter actuator valve body outlet. In a preferred embodiment, the diverter actuator stem can also be rotated to a third or intermediate position to enable the water to flow through both the first diverter actuator valve body outlet and the second diverter actuator valve body outlet simultaneously. In this manner the diverter valve system diverts water from the water supply inlet to the first and/or the second water outlet. When the filtration member is in place, water under pressure flows in through the water supply inlet, through the valve cap flowpath, down through the filtration member, through the diverter valve system flowpath, and out of the water outlet. Suitable diverter valves for use in the present diverter valve system include a tee diverter valve, two-valve diverter valve, and three-valve diverter valve and can be 2-way, 3-way, or more. For instance, the diverter valve can be a 2-way diverter configured to divert filtered water to either a showerhead or a hand shower or an emergency shower or an eyewash. Alternatively, the diverter valve can be a 3-way diverter valve configured to divert filtered water to a showerhead, a hand shower, or a body sprayer. In a preferred embodiment, the diverter valve is a rotatable actuator stem that rotates within a cylindrical body as shown in FIGS. 5, 6E, and 6F.

FIG. 1 depicts a shower system that incorporates an embodiment of the filtered diverter valve system of the invention. The shower system 1 includes a showerhead 3 and a hand shower 4. The filtered diverter system 5 is attached to the shower arm 2, showerhead 3, and hose 6 of the hand shower 4. The user can rotate the control device 8 (e.g., knob or diverter handle) to divert the flow of water from the hand shower 4 to the showerhead 3, from the showerhead 3 to the hand shower 4, or to both the hand shower 4 and showerhead 3 simultaneously. To use the hand shower, the user holds the hand shower handle 7 and detaches the hand shower 4 from the holder 9.

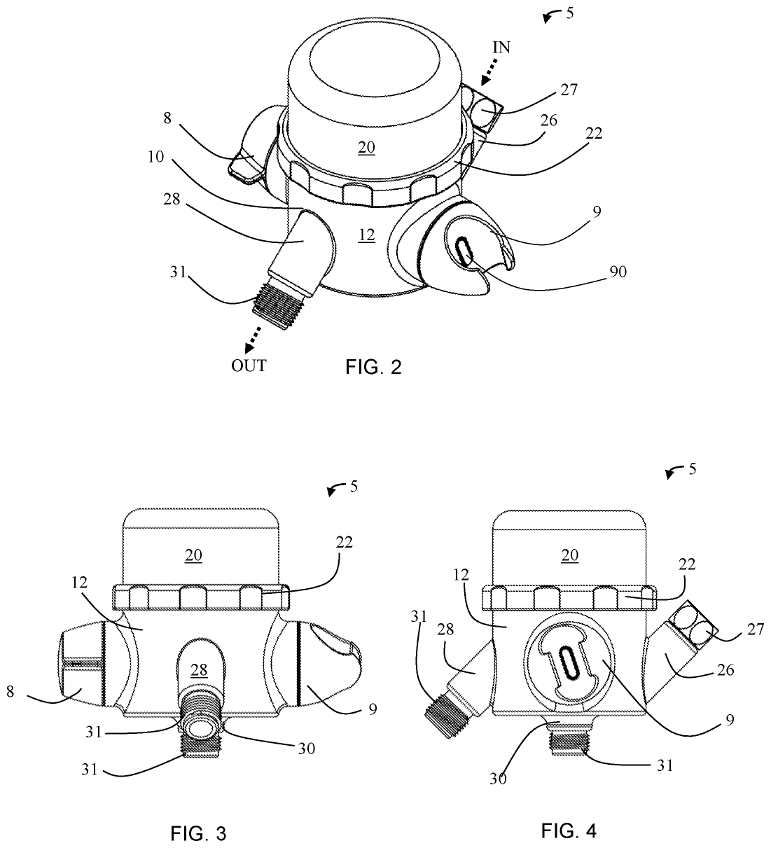

The exemplary filtered diverter valve system 5 is shown in more detail in FIGS. 2-7. As shown in FIGS. 2-4, the filtered diverter valve system 5 includes a lower valve body 10 encased by a lower valve body housing 12 and a valve cap 20 that attaches to the lower valve body housing 12. The attachment of the valve cap 20 to the lower valve body housing 12 can be facilitated by turning the locking ring 22. The lower valve body housing 12 has a water supply inlet 26, a first water outlet 28, and a second water outlet 30. Each of these inlet and outlets is machined into the lower valve body housing 12 of the lower valve body 10. The water supply inlet 26 includes an attachment member 27, which may comprise a swivel nut or similar component that can be used to attach the filtered diverter valve system 5 to the shower arm 2, from which water under pressure can be delivered into the filtered diverter valve system 5. In this particular embodiment, the first water outlet 28 will attach to the showerhead 3, whereas the second water outlet 30 will attach to the hose 6 of the hand shower 4. Each of the first and second water outlets 28, 30 will include an attachment component 31, such as art-standard ½″-14 NPT threads or NPSM threads, for attaching to the showerhead 3 and hand shower 4 as is well understood in the art. To divert water between the showerhead 3 and hand shower 4, the user operates the control device 8 by turning clockwise or counterclockwise, which, in turn, rotates the diverter actuator stem 50 within the diverter actuator body 52 (see FIGS. 5 and 6).

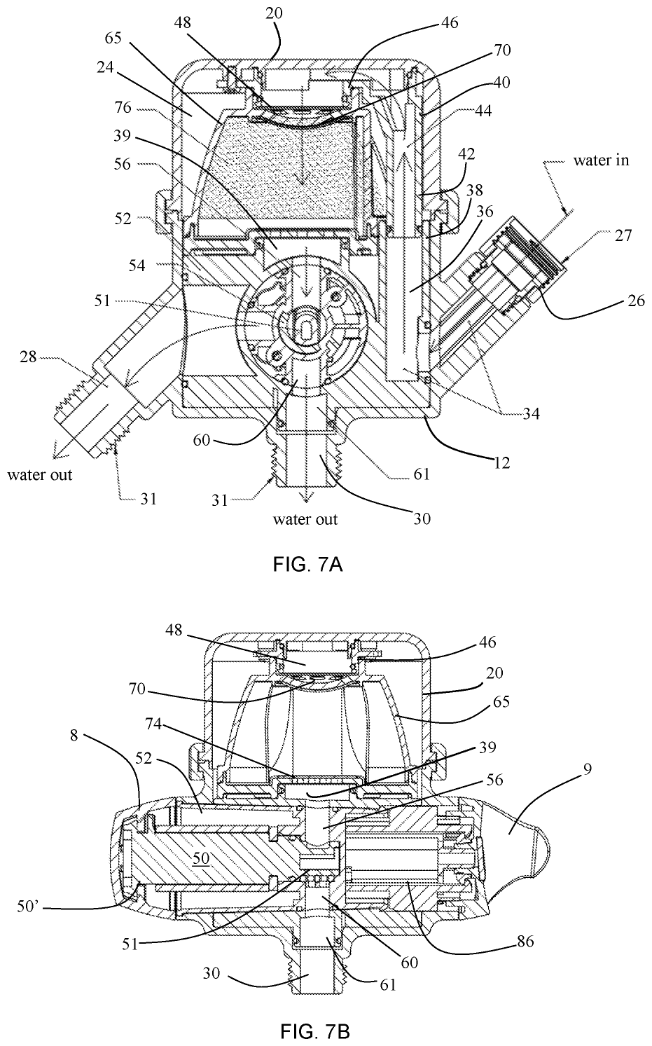

FIG. 5 is an exploded view of the filtered diverter valve system 5. The lower valve body 10 includes the lower valve body housing 12. Within the lower chamber 14 of the lower valve body housing 12 is the diverter valve system that includes a diverter valve system housing 32 (see also FIG. 6D for an enlarged depiction of the diverter valve system housing). As noted above, the valve cap 20 is attached to the lower valve body housing 12 via locking ring 22. When attached, the valve cap 20, lower valve body housing 12, and diverter system housing 32 cooperate to form the water flow path from the water supply inlet 26 through the filtration member 65 and diverter system before exiting the filtered diverter valve system 5 to the showerhead 3 and/or hand shower 4. Moreover, the top 18 of the diverter valve system housing 32 serves as the partition between the upper chamber 24 of the valve cap 20 and the lower chamber 14 of the lower valve body housing 12. As shown in FIGS. 5 and 6D, the diverter system housing 32 has a flowpath 36 in fluid communication with the lower valve body inlet flowpath 34 of the water supply inlet 26 (see also FIG. 7A for an illustration of the communication between flowpaths 34 and 36 and the water supply inlet 26). The flowpath 36 extends substantially vertically from the diverter valve system housing 32 and forms a bore 38. The valve cap 20 includes a waterway adapter 40, which includes a downwardly extending waterway inlet tube 42 and an upper portion 46 having a cap flowpath outlet 48. The inlet tube 42, upper portion 46, and cap flowpath outlet 48 form the valve cap flowpath 44. The upper portion 46 of the waterway adapter 40 is attached to a mating flange on the underside of the valve cap 20 by way of screws 49. An o-ring 41 can be used to create a watertight connection between the waterway adapter 40 and the valve cap 20.

In this embodiment, the waterway inlet tube 42 is concentrically inserted into bore 38 of the diverter valve system housing 32. Thus, this allows for removal of the valve cap 20 from the lower valve body housing 12 to access the filtration member 65. When the valve cap 20 is connected to the lower valve body housing 12, and the waterway inlet tube 42 is inserted into the bore 38, the valve cap flowpath 44 is in fluid communication with the flowpath 36 of the diverter valve system housing, the lower valve body inlet flowpath 34, and the water supply inlet 26. The connection between the waterway inlet tube is 42 and the bore of the diverter system housing 32 can be made watertight by the addition of an o-ring 43. Alternatively, the valve cap flowpath can be formed from a continuous tube or pipe that is detached from the valve cap 20 when the valve cap 20 is separated from the lower valve body housing 12.

As shown in FIGS. 5 and 6D-6F, the diverter valve system further includes a diverter actuator stem 50, a cylindrical diverter actuator body 52, and a diverter seal 54. The diverter actuator stem 50 rotates within the cylindrical diverter actuator body 52 and held into place by c-clip 53. Both the diverter actuator stem 50 and the diverter actuator body 52 are disposed within the diverter valve system housing 32. The diverter actuator body 52 has a diverter body inlet 56, a first diverter body outlet 58, and a second diverter body outlet 60. The diverter body inlet 56 is in fluid communication with the diverter system housing inlet 39 to receive filtered water from the filtration member 65 as described below. Moreover, the first diverter body outlet 58 aligns with the first diverter housing outlet 59 and is in fluid communication with the first water outlet 28, and the second diverter body outlet 60 aligns with the second diverter housing outlet 61 and is in fluid communication with the second water outlet 30.

The diverter seal 54 is sealed against the seal end 51 of the diverter actuator stem 50, and also against the first diverter body outlet 58 and the second diverter body outlet 60. The diverter actuator stem 50 is attached to the control device 8 by insertion of the attachment end 50′ into the control device 8 such that rotation of the control device 8 clockwise or counterclockwise rotates the diverter actuator stem 50 within the diverter actuator body 52. In this embodiment, the diverter seal 54 has four openings (not shown), two in fluid communication with the first diverter body outlet 58, and two in fluid communication with the second diverter body outlet 60. When the diverter actuator stem 50 is in the first position, it closes the two openings in the diverter seal 54 for the second diverter body outlet 60, and water flows over the diverter actuator stem 50, through the two openings in the diverter seal 54 for the first diverter outlet 58, and out the first water outlet 28 to the showerhead 3. When the diverter actuator stem 50 is rotated to the second position, the two openings in the diverter seal for the second diverter body outlet 60 are opened while the two openings in the diverter seal 54 for the first diverter body outlet 58 are closed, and water flows over the diverter actuator stem 50, through two openings in the diverter seal 54 for the second diverter body outlet 60, and out the second water outlet 30 to the hand shower 4. When the divert actuator stem 50 is rotated to a middle or third position, all four openings in the diverter seal 54 are opened allowing water to flow through both the first diverter body outlet 58 and the second diverter body outlet 60 simultaneously. The flow of water from the diverter valve housing inlet 39 through the diverter body inlet 56 and out of the first and/or second diverter body outlets form the diverter valve system flowpath. The various connections and openings between the diverter actuator stem 50, the diverter actuator body 52, the diverter system housing 32, and the lower valve body housing 12 can be made watertight by the use of o-rings 63.

In the embodiment shown in FIG. 5, a tactile dentate mechanism is utilized so that the user is made aware of the rotation positions of the diverter actuator stem. Thus, a spring-loaded cap 62, 64 is incorporated into the rotation system and follows a mogul-like track concentric to the diverter actuator stem 50. The cap 64 snaps down upon reaching the dentate, making an audible click, and is pushed back up when reaching the flat surface of the diverter actuator stem 50.

Also shown in FIGS. 5 and 6A-C is an exemplary disposable filtration member 65. The filtration member 65 is cylindrical in shape with upwardly tapering sidewalls 66. The filtration member 65 includes a top portion 68 having an inlet opening 70, optionally covered with wire mesh, for receiving water and a bottom portion 72 having a plurality of outlet openings 74 for flowing filtered water. The exemplary filtration member shown in FIGS. 5 and 6A-C is generally cylindrical and filled with, e.g., KDF-55 filter medium 76.

When in use, the filtration member 65 is placed onto the top surface 18 of the diverter system housing 32, which has a circumferential mating flange 33 that is received by the bottom circumferential mating flange 68 on the bottom portion 72 of the filtration member 65 such that the outlet openings 74 are in fluid communication with the diverter housing inlet 39 (see FIGS. 5, 6A-6D). Similarly, the top portion 68 of the filtration member 65 includes a top circumferential mating flange 80 that is received by the upper portion 46 of the waterway adapter 40 such that the cap flowpath outlet 48 is in fluid communication with the filtration member inlet opening 70. The filtration member 65 may also include a notch 82 for providing space of the bore 38 and waterway inlet tube 42. The filtration member 65 can either be first inserted into the upper chamber 24 of the valve cap 20 or first disposed onto the top surface 18 of the diverter system housing 32. The connections between the filtration member 65 and the waterway adapter 40 and diverter system housing 32 can be made watertight with the insertion of o-rings 84. The valve cap 20 is attached to the lower valve body housing 12 via the locking ring 22 to create a continuous flowpath from the water supply inlet 26, through the valve cap flowpath 44, down into the filtration member inlet opening 70 and over the filter medium 76, out the filtration member outlet openings 74 and into the diverter valve system housing inlet 39.

Other features shown in FIG. 5 include a retainer 86 that is fastened to the diverter body 52 and hand shower clip 88. The holder 9 is then snapped over the clip 88 and may optionally include a rubber retaining pad 90 to provide extra grip onto the hand shower handle 7 to ensure that the hand shower 4 does not fall out of the holder 9. The snap connection allows the holder 9 to be rotated 360 degrees, but can be held into place via a plurality of dentates on the retainer 86.

FIGS. 7A and 7B illustrate the flow of water through the filtered diverter valve system 5. As water flows into the water supply inlet 26, it travels through the lower valve body inlet flowpath 34 and up the flowpath 36 in the diverter system housing 32 to the cap flowpath 44 of the waterway adapter 40. As the water flows upwards through the waterway adapter 40, it travels to and then out the valve cap flowpath outlet 48 of the waterway adapter 40. The water flows across the wire mesh covering the inlet opening 70 of the filtration member 65 and into the filter medium 76. As the water flows over the filter medium 76, various contaminants and other undesired particles are removed depending on the type of filter medium 76 selected. The filtered water then flows out of the outlet openings 74, which preferably are also covered with a wire mesh, and into the diverter valve system housing inlet 39. From here, the filtered water enters into the diverter actuator body 52 via the diverter body inlet 56. Depending on the rotation position of the diverter actuator stem 50, the filtered water is diverted out of the first diverter body outlet 58 and ultimately the first water outlet 28, out of the second diverter body outlet 60 and ultimately the second water outlet 30, or simultaneously out of both of the first diverter body outlet 58 and the second diverter body outlet 60. In this manner, filtered water can be diverted to the showerhead 3 and/or the hand shower 4.

In some embodiments, and as mentioned above, the lower chamber of the lower valve body is configured for insertion of the filtration member such that the filtration member is disposed adjacent to the diverter valve system. In this embodiment, the flowpath from the water supply inlet to the filtration member may be contained within the lower chamber. The diverter valve system housing will contain a bore or flowpath from the filtration member to the divert actuator stem. This embodiment of the filtered diverter system may still include a detachable valve cap to allow the end-user easy access to the filtration member. The diameter of the lower valve body may be increased to accommodate a lower chamber of sufficient size to accept both the diverter valve system housing and the filtration member, while the overall height of the device may be decreased.

For assembling to existing shower systems, the end-user uncouples the showerhead from the shower arm to expose the attachment component of the shower arm, which can be pipe threading, pipe slip coupling, swivel nut, or other means of attachment typical in the art. The filtered diverter valve system is then attached to the shower arm such that the water supply inlet is directly connected to the shower arm outlet. Then, the end-user connects one of the water outlets to the showerhead such that the water outlet is directly connected to the showerhead inlet. The end-user can then plug the second water outlet with, e.g., a stopper or screw plug, or attach the hose of a hand shower or other plumbing fixture to the second water outlet. The end-user then selects a filtration member having the desired filter medium or media and places the filtration member into the upper chamber of the valve cap, such that the inlet at the top of the filtration member is in direct fluid communication with the valve cap flowpath. The end-user then affixes the valve cap to the lower valve cap such that the outlet at the bottom of the filtration member is in direct fluid communication with the diverter valve system flowpath to complete the water flowpath. Alternatively, the end-user can first place the filtration member on top of the diverter valve system housing or chamber partition such that the outlet of the filtration member is in direct fluid communication with the diverter valve system flowpath, and then affix the valve cap onto the lower valve body housing.

The end-user turns on the flow of water, which flows out of the shower arm and into the filtered diverter valve system via the water supply inlet. The water flows up the valve cap flow path and down into the filtration member through the wire mesh to remove larger particles. The water flows through and around the filter medium or media, which removes contaminants, such as chlorine, and dirt and mineral particles. The filtered water passes into the diverter valve actuator system. The end-user turns the control device from a first position to a second position, which moves the diverter actuator stem from the first position to the second position thus diverting the flow of water from the showerhead to the hand shower. The end-user can turn the knob from the second position to the first position, which moves the diverter actuator stem from the second position to the first position thus diverting water from the hand shower to the showerhead. As noted above, the end-user can turn the know to a third, or intermediate position, which moves the diverter actuator stem to a third, or intermediate position, thus flowing water to both the showerhead and hand shower simultaneously.

In particular embodiments, the filtration member will be a disposable filtration member. In such embodiments, the filtration member will work effectively from between about 3 months to about 12 months, e.g., 3, 4, 5, 6, 7, 8, 9, 10, 11, or 12 months as is typical for water filtration systems. To replace the filtration member, the end-user uncouples the valve cap from the lower portion of the valve body to access the used filtration member. The end-user removes the old filtration member and replaces with the new one.

### REFERENCE NUMBERS

1—shower system
2—shower arm
3—showerhead
4—hand shower
5—filtered diverter valve system
6—hose
7—hand shower handle
8—control device
9—holder
10—lower valve body
12—lower valve body housing
14—lower chamber
16—bottom
18—top surface of diverter valve system housing
20—valve cap
22—locking ring
24—upper chamber
26—water supply inlet
27—attachment component (swivel nut)
28—first water outlet (showerhead)
30—second water outlet (hand shower)
31—attachment component (threads)
32—diverter valve system housing
33—mating flange (diverter housing)
34—lower valve body inlet flowpath
36—to cap flowpath
38—diverter housing bore
39—diverter housing inlet
40—waterway adapter
41—o-ring (valve cap)
42—waterway inlet tube
43—o-ring (inlet tube and bore connection)
44—valve cap flowpath
46—upper portion of waterway adapter
48—valve cap flowpath outlet
49—screws
50—diverter actuator stem
50′—diverter actuator attachment end
51—diverter actuator seal end
52—diverter actuator body
53—c-clip
54—diverter seal
56—diverter actuator body inlet
58—first diverter body outlet (showerhead)
59—first diverter housing outlet
60—second diverter valve outlet (hand shower)
61—second diverter housing outlet
62—spring
63—o-rings
64—cap
65—filtration member
66—tapered side walls
68—top (filtration member)
70—filtration member inlet opening (mesh)
72—bottom (filtration member)
74—filtration member outlet openings
76—filter medium
78—bottom circumferential mating flange (filtration member)
80—top circumferential mating flange (filtration member)
82—filtration member notch
84—o-rings
86—retainer
88—clip
90—retaining pad

We claim:

1. A filtered diverter valve system comprising:
a lower valve body comprising a lower chamber, a water supply inlet for connecting the filtered diverter valve system to a supply of water, a first water outlet, and a second water outlet, wherein the first water outlet is configured for connecting to a first plumbing fixture and the second water outlet is configured for connecting to a second plumbing fixture, and wherein the lower chamber comprises a bottom portion and a top partition, the top partition having a diverter valve flowpath configured to receive flow of water;
a valve cap comprising an upper chamber for receiving a disposable filtration member, wherein the valve cap further comprises a valve cap flowpath in fluid communication with the water supply inlet and configured to receive flow of water, wherein the valve cap flowpath comprises an opening in fluid communication with the disposable filtration member when the disposable filtration member is disposed within the upper chamber;
a diverter valve member disposed within the lower chamber of the lower valve body, wherein the diverter valve member has (i) a diverter inlet in fluid communication with the diverter valve flowpath, (ii) at least one diverter outlet for fluid communication with the first water outlet, the second water outlet, or both the first water outlet and the second water outlet, and (iii) a diverter actuator movable between a first position and a second position, and wherein the diverter inlet and diverter valve flowpath are in fluid communication with the disposable filtration member when the disposable filtration member is disposed within the upper chamber; and
a control device for moving the diverter actuator between the first position and the second position, wherein water is diverted to the first water outlet when the diverter actuator is in the first position, and wherein water is diverted to the second water outlet with the diverter actuator is in the second position.

2. The filtered diverter valve system of claim 1, wherein the diverter actuator is moveable to a third position, and wherein water is diverted to both the first water outlet and the second water outlet when the diverter actuator is in the third position.

3. The filtered diverter valve system of claim 1, wherein the diverter valve member has a first diverter outlet in fluid communication with the first water outlet and a second diverter outlet in fluid communication with the second water outlet, and wherein the movement of the diverter actuator between the first position and the second position enables flow of water to the first water outlet and the second water outlet, respectively.

4. The filtered diverter valve system of claim 1, further comprising a filtration member disposed within the upper chamber of the valve cap.

5. The filtered diverter valve system of claim 4, wherein the filtration member comprises a filter medium selected from the group consisting of polyphosphate, mesh, ceramic, activated carbon, catalytic carbon, silver carbon, kinetic degradation fluxion, a reverse osmosis membrane, activated aluminum, manganese dioxide, and any combination thereof.

6. The filtered diverter valve system of claim 1, wherein the water supply inlet extends upward from the lower valve body at an angle of about 0 degrees to about 60 degrees in relation to the horizontal axis of the lower valve body.

7. The filtered diverter valve system of claim 6, wherein the first water outlet is on a side of the lower valve body opposite the water supply inlet and extends downward from the lower valve body at an angle of about 0 degrees to about 60 degrees in relation to the horizontal axis of the lower valve body.

8. The filtered diverter valve system of claim 7, wherein the water supply inlet extends upward from the lower valve body at an angle of about 35 degrees to about 55 degrees and the first water supply outlet extends downward from the lower valve body at an angle of about 35 degrees to about 55 degrees.

9. The filtered diverter valve system of claim 1, wherein the second water outlet extends downward from the bottom of the lower valve body.

10. The filtered diverter valve system of claim 1, wherein the diverter valve member further comprises a housing in which is disposed the diverter actuator.

11. The filtered diverter valve system of claim 1, wherein the diverter actuator is a diverter actuator stem configured for rotation within a cylindrical body.

12. The filtered diverter valve system of claim 1, wherein the valve cap comprises a waterway adapter having a tube that is concentrically received within a counterpart inlet tube within the housing of the diverter valve member, and wherein the tube of the waterway adapter and tube of the housing of the diverter valve member are configured to flow water from the water supply inlet to the valve cap flowpath.

13. The filtered diverter valve system of claim 1, wherein the filtration member comprises an interior enclosed by cylindrical side walls, a top, and a bottom, wherein the top has a top opening in fluid communication with the valve cap flowpath, wherein the bottom has a bottom opening in fluid communication with the diverter valve flowpath, and wherein the filter medium is disposed within the interior and configured for filtering water flowing through the filtration member.

14. The filtered diverter valve system of claim 13, wherein the top opening of the filtration member and the bottom opening of the filtration member are covered with a wire mesh and wherein the cylindrical side walls taper towards the top.

15. The filtered diverter valve system of claim 1, wherein the first plumbing fixture is a showerhead, and wherein the second plumbing fixture is a hand shower.

16. A filtered diverter valve system comprising:
a lower valve body comprising a diverter valve housing comprising a diverter valve flowpath, a water supply inlet for connecting the filtered diverter valve system to a supply of water, a first water outlet, and a second water outlet, wherein the first water outlet is configured for connecting to a first plumbing fixture and the second water outlet is configured for connecting to a second plumbing fixture;
a valve cap comprising an upper chamber for receiving a disposable filtration member, wherein the valve cap further comprises a valve cap flowpath in fluid communication with the water supply inlet and configured to receive flow of water, wherein the valve cap flowpath comprises an opening in fluid communication with the disposable filtration member when the disposable filtration member is disposed within the upper chamber;
a diverter valve member disposed within the diverter valve housing, wherein the diverter valve member comprises a diverter inlet in fluid communication with the diverter valve flowpath, a first diverter outlet in fluid communication with the first water outlet, a second diverter outlet in fluid communication with the second water outlet, and a diverter actuator movable between a first position and a second position, and wherein the diverter inlet and diverter valve flowpath are in fluid communication with the disposable filtration member when the disposable filtration member is disposed within the upper chamber; and
a control device for moving the diverter actuator between the first position and the second position, wherein water is diverted to the first water outlet when the diverter actuator is in the first position, and wherein water is diverted to the second water outlet with the diverter actuator is in the second position.

17. The filtered diverter valve system of claim 16, wherein the diverter actuator is moveable to a third position, and wherein water is diverted to both the first water outlet and the second water outlet with the diverter actuator is in the third position.

18. The filtered diverter valve system of claim 16, further comprising a filtration member disposed within the upper chamber of the valve cap, wherein the filtration member comprises a filter medium selected from the group consisting of polyphosphate, mesh, ceramic, activated carbon, catalytic carbon, silver carbon, kinetic degradation fluxion, a reverse osmosis membrane, activated aluminum, manganese dioxide, and any combination thereof.

19. The filtered diverter valve system of claim 16, wherein the diverter actuator is a diverter actuator stem configured for rotation within a cylindrical body.

20. The filtered diverter valve system of claim 1, wherein the valve cap comprises a waterway adapter having a tube that is concentrically received within a counterpart inlet tube within the diverter valve housing, and wherein the tube of the waterway adapter and tube of the diverter valve housing are configured to flow water from the water supply inlet to the valve cap flowpath.
